(19) United States
(12) Patent Application Publication
(10) Pub. No.: US 2025/0244650 A1
(43) Pub. Date: Jul. 31, 2025

(54) PROJECTOR

(71) Applicant: SEIKO EPSON CORPORATION, Tokyo (JP)

(72) Inventors: Yutaka AMANO, MATSUMOTO-SHI (JP); Ayumu KOBAYASHI, MATSUMOTO-SHI (JP); Masashi KATO, AZUMINO-SHI (JP); Shunji KATAOKA, MATSUMOTO-SHI (JP)

(21) Appl. No.: 19/036,484

(22) Filed: Jan. 24, 2025

(30) Foreign Application Priority Data
Jan. 26, 2024 (JP) 2024-009908

(51) Int. Cl. G03B 21/20

(52) U.S. Cl. CPC G03B 21/2013; G03B 21/2066; G03B 21/2073

(57) ABSTRACT

A projector includes a first light source configured to output first light having a first wavelength band; a first light guide that the first light output from the first light source enters; a first light modulator configured to modulate the first light output from the first light guide based on image information to generate image light having the first wavelength band; and a projection system configured to project the light modulated by the first light modulator, the first light guide having an inner surface configured to reflect the first light, the inner surface including a first surface having a largest area out of surfaces that constitute the inner surface, reflectance of the first surface for a first polarized component being higher than reflectance of the first surface for a second polarized component, and the first light modulator configured to modulate the first polarized component to generate the image light.

The present application is based on, and claims priority from JP Application Serial Number 2024-009908, filed Jan. 26, 2024, the disclosure of which is hereby incorporated by reference herein in its entirety.

### BACKGROUND

### 1. Technical Field

The present disclosure relates to a light modulating projector including a light source.

### 2. Related Art

There is a known projector including LEDs that each emit light, a block that outputs the light emitted from each of the LEDs via a light exiting end in such a way that the output light has uniform brightness, a condenser lens that forms a light source image of the light output from the block at the entrance pupil position of a projection lens, a light modulator that generates image light, and the projection lens (see JP-A-2000-180962).

JP-A-2000-180962 is an example of the related art.

In the projector described in JP-A-2000-180962, since LEDs are used as the light source, the light emitted from each of the LEDs is not linearly polarized light. Therefore, when a liquid crystal panel is used, it is necessary to align the polarized components with one another before the light enters the panel, so that a large amount of the light is lost, resulting in a problem of poor light use efficiency.

### SUMMARY

A projector according to an aspect of the present disclosure includes a first light source configured to output first light having a first wavelength band; a first light guide having a first light incident end on which the first light output from the first light source is incident, and a first light exiting end via which the first light exits; a first light modulator configured to modulate the first light output from the first light guide based on image information to generate image light having the first wavelength band; and a projection system configured to project the light modulated by the first light modulator, the first light output from the first light source containing a first polarized component and a second polarized component, the first light guide having an inner surface configured to reflect the first light, the inner surface including a first surface having a largest area out of surfaces that constitute the inner surface, reflectance of the first surface for the first polarized component being higher than the reflectance of the first surface for the second polarized component, and the first light modulator configured to modulate the first polarized component to generate the image light.

### BRIEF DESCRIPTION OF THE DRAWINGS

FIG. 1 is a conceptual plan view illustrating a projector according to an embodiment.

FIG. 2 is a perspective view showing the interior of a first light guide.

FIG. 3 is a front view, a plan cross-sectional view, and a side cross-sectional view showing the interior of the first light guide.

FIG. 4 is a chart for illustrating the characteristics of a light source apparatus and reflection characteristics of reflection films.

FIG. 5 is a chart for illustrating the dependence of the reflectance of the reflective films on the angle of incidence.

FIG. 6A shows the dependence of the reflectance of the reflection film for white light on the angle of incidence.

FIG. 6B shows the dependence of the reflectance of the reflection film for red light, that is, first light on the angle of incidence.

FIG. 7A shows the dependence of the reflectance of the reflection film for green light, that is, second light on the angle of incidence.

FIG. 7B shows the dependence of the reflectance of the reflection film for blue light, that is, third light on the angle of incidence.

FIG. 8 is a front view for illustrating a variation of the first light guide shown in FIG. 2 and the like.

FIG. 9 is a plan view for illustrating a variation of the projector shown in FIG. 1.

### DESCRIPTION OF EMBODIMENTS

A projector for color image projection that is an embodiment of the present disclosure will be described below with reference to the drawings.

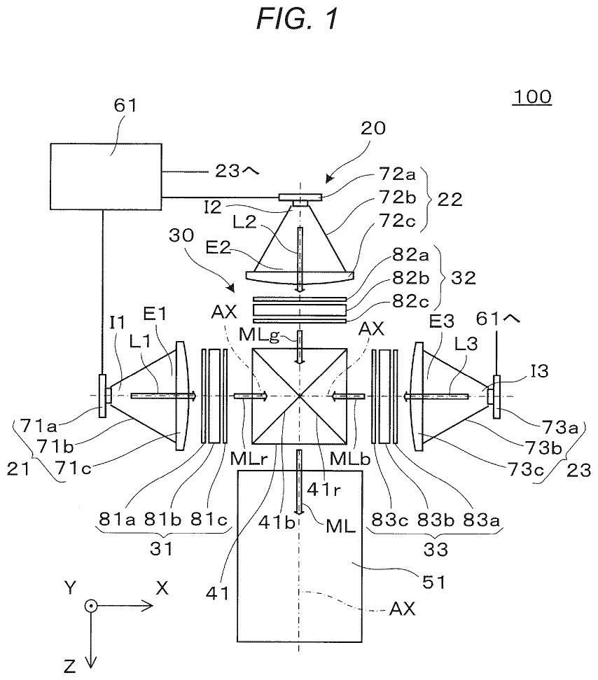

FIG. 1 is a conceptual plan view illustrating a projector 100 according to the embodiment. In FIG. 1, X, Y, and Z constitute an orthogonal coordinate system.

The projector 100 shown in FIG. 1 includes an illuminator 20, a light modulating apparatus 30, a light combiner 41, a projection system 51, and a drive circuit 61. The illuminator 20 includes a first light source apparatus 21, a second light source apparatus 22, and a third light source apparatus 23, and the light modulating apparatus 30 includes a first light modulating device 31, a second light modulating device 32, and a third light modulating device 33.

In the illuminator 20, the first light source apparatus 21 supplies the light modulating apparatus 30 with homogenized first light L1, specifically, homogenized red light. The first light source apparatus 21 includes a first light source 71a, which outputs the first light L1 having a first wavelength band, a first light guide 71b, which guides the first light L1 output from the first light source 71a while reflecting the first light L1, and a parallelizing lens 71c, which adjusts the divergence state of the first light L1 output from the first light guide 71b. The first light guide 71b has a first light incident end I1, to which the first light source 71a is fixed via a coupling member that is not shown, and a first light exiting end E1, to which the parallelizing lens 71c is fixed via a coupling member that is not shown.

In the first light source apparatus 21, the first light source 71a is, for example, an LED (light emitting diode) in the form of one package that incorporates one or more LED chips. The first light source 71a may instead be two-dimensionally arranged multiple LED packages. The first light source 71a may be provided with a reflector around the light emitting portion. The first wavelength band corresponding to the wavelength of the first light L1 is set at, but not limited to, for example, a range from 600 nm to 650 nm.

The first light guide 71b has a truncated pyramidal external shape having a cross-sectional size perpendicular to an optical axis AX increasing as extending from the first light source 71a toward the parallelizing lens 71c, and has a hollow interior. The first light guide 71b has a rectangular cross-sectional shape perpendicular to the optical axis AX thereof. The first light guide 71b reflects the first light L1 from the first light source 71a off the inner surface of the first light guide 71b to homogenize the first light L1 while preventing the first light L1 from diverging, and causes the homogenized first light L1 to enter the first light modulating device 31 via the parallelizing lens 71c.

The second light source apparatus 22 supplies the light modulating apparatus 30 with homogenized second light L2, specifically, homogenized green light. The second light source apparatus 22 includes a second light source 72a, which outputs the second light L2 having a second wavelength band, a second light guide 72b, which guides the second light L2 output from the second light source 72a while reflecting the second light L2, and a parallelizing lens 72c, which adjusts the divergence state of the second light L2 output from the second light guide 72b. The second light guide 72b has a second light incident end 12, to which the second light source 72a is fixed via a coupling member that is not shown, and a second light exiting end E2, to which the parallelizing lens 72c is fixed via a coupling member that is not shown.

In the second light source apparatus 22, the second light source 72a is, for example, an LED in the form of one package that incorporates one or more LED chips. The second light source 72a may instead be two-dimensionally arranged multiple LED packages, or may be provided with a reflector around the light emitting portion. The second wavelength band corresponding to the wavelength of the second light L2 is set at, but not limited to, for example, a range from 500 nm to 600 nm.

The second light guide 72b has a truncated pyramidal external shape and has a hollow interior, as the first light guide 71b of the first light source apparatus 21. The second light guide 72b has a rectangular cross-sectional shape perpendicular to the optical axis AX thereof. The second light guide 72b reflects the second light L2 from the second light source 72a off the inner surface of the second light guide 72b to homogenize the second light L2 while preventing the second light L2 from diverging, and causes the homogenized second light L2 to enter the second light modulating device 32 via the parallelizing lens 72c.

The third light source apparatus 23 supplies the light modulating apparatus 30 with homogenized third light L3, specifically, homogenized blue light. The third light source apparatus 23 includes a third light source 73a, which outputs the third light L3 having a third wavelength band, a third light guide 73b, which guides the third light L3 output from the third light source 73a while reflecting the third light L3, and a parallelizing lens 73c, which adjusts the divergence state of the third light L3 output from the third light guide 73b. The third light guide 73b has a third light incident end 13, to which the third light source 73a is fixed via a coupling member that is not shown, and a third light exiting end E3, to which the parallelizing lens 73c is fixed via a coupling member that is not shown.

In the third light source apparatus 23, the third light source 73a is, for example, an LED in the form of one package that incorporates one or more LED chips. The third light source 73a may instead be two-dimensionally arranged multiple LED packages, or may be provided with a reflector around the light emitting portion. The third wavelength band corresponding to the wavelength of the third light L3 is set at, but not limited to, for example, a range from 400 nm to 500 nm.

The third light guide 73b has a truncated pyramidal external shape and has a hollow interior, as the first light guide 71b of the first light source apparatus 21. The third light guide 73b has a rectangular cross-sectional shape perpendicular to the optical axis AX thereof. The third light guide 73b reflects the third light L3 from the third light source 73a off the inner surface of the third light guide 73b to homogenize the third light L3 while preventing the third light L3 from diverging, and causes the homogenized third light L3 to enter the third light modulating device 33 via the parallelizing lens 73c.

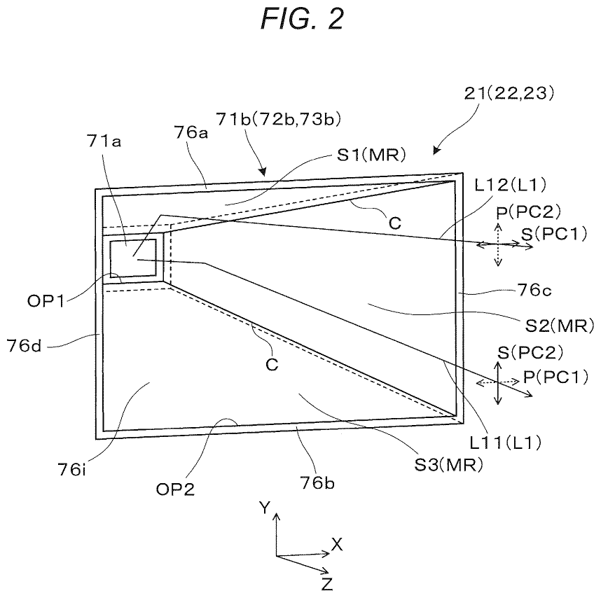

In the light modulating apparatus 30, the first light modulating device 31 is a transmissive light modulating device, specifically, a liquid crystal panel. The first light modulating device 31 includes a first polarizer 81a, a first light modulator 81b, and a second polarizer 81c, and modulates the first light L1 output from the first light guide 71b based on red component image information input from the drive circuit 61 to generate image light MLr having the first wavelength band corresponding to red. The first polarizer 81a is disposed between the first light guide 71b and the first light modulator 81b, transmits light having a first polarized component PC1 having an electric field oscillating in the lateral X direction out of the first light L1, and reflects and hence attenuates light having a second polarized component PC2 perpendicular to the first polarized component PC1 (see FIG. 2 for the polarized components PC1 and PC2). That is, a polarization axis of the first polarizer 81a coincides with the lateral X direction. The first light modulator 81b is made, for example, of an in-plane-switching (IPS) liquid crystal material or a twisted-nematic (TN) liquid crystal material, includes two-dimensionally arranged pixels (not shown), and operates on a pixel basis. The first light modulator 81b can change the polarization direction of the incident light on a pixel basis in accordance with gradation in the red component image information. To this end the first light modulator 81b includes, although not shown, a liquid crystal layer, a common electrode, pixel electrodes, and other elements. The second polarizer 81c is disposed at the side of the first light modulator 81b that is opposite the first polarizer 81a, transmits the light having the first polarized component PC1, the electric field of which oscillates in the lateral X direction, out of the first light L1, and absorbs and hence attenuates the light having the second polarized component PC2. The second polarizer 81c does not necessarily have a polarization axis that coincides with the lateral X direction and may instead have a polarization axis that coincides with the longitudinal Y direction and transmit the light having the second polarized component PC2. In this case, the pixel-on operation and the pixel-off operation are swapped.

The second light modulating device 32 is a transmissive light modulating device having the same structure as the first light modulating device 31, and includes a first polarizer 82a, a second light modulator 82b, and a second polarizer 82c. The second light modulating device 32 modulates the second light L2 output from the second light guide 72b based on green component image information input from the drive circuit 61 to generate image light MLg having the second wavelength band corresponding to green. In the second light modulating device 32, the first polarizer 82a is disposed between the second light guide 72b and the second light modulator 82b, and has a polarization axis that coincides with the Z direction, which is the lateral direction, as the first polarizer 81a of the first light modulating device 31. The second light modulator 82b is made, for example, of the IPS or TN liquid crystal material, includes two-dimensionally arranged pixels (not shown), and operates on a pixel basis. The second light modulator 82b can change the polarization direction of the incident light on a pixel basis in accordance with gradation in the green component image information. Note that the second polarizer 82c, for example, has a polarization axis that coincides with the Z direction, which is the lateral direction, as the first polarizer 82a.

The third light modulating device 33 is a transmissive light modulating device having the same structure as the first light modulating device 31, and includes a first polarizer 83a, a third light modulator 83b, and a second polarizer 83c. The third light modulating device 33 modulates the third light L3 output from the third light guide 73b based on blue component image information input from the drive circuit 61 to generate image light MLb having the third wavelength band corresponding to blue. In the third light modulating device 33, the first polarizer 83a is disposed between the third light guide 73b and the third light modulator 83b, and has a polarization axis that coincides with the X direction, which is the lateral direction, as the first polarizer 81a of the first light modulating device 31. The second light modulator 82b is made, for example, of the IPS or TN liquid crystal material, includes two-dimensionally arranged pixels (not shown), and operates on a pixel basis. The third light modulator 83b can change the polarization direction of the incident light on a pixel basis in accordance with gradation in the blue component image information. Note that the second polarizer 83c, for example, has a polarization axis that coincides with the X direction, which is the lateral direction, as the first polarizer 83a.

The light combiner 41 is a block-shaped member in which four right-angled triangular prisms made, for example, of a glass material are so bonded to each other that the ridges of the four prisms coincide with one another, and has a structure in which two dichroic mirrors 41r and 41b perpendicular to each other are buried at the portion where the four prisms are bonded to each other. The dichroic mirror 41r forms a surface that links two corners of the square contour of the light combiner 41 to each other when viewed in the Y direction parallel to the intersection axis of the light combiner 41. The other dichroic mirror 41b forms a surface that links the other two corners of the square contour of the light combiner 41 to each other when viewed in the Y direction parallel to the intersecting axis of the light combiner 41.

The image light MLr having entered the light combiner 41 from the first light modulating device 31 for red and having the first wavelength band corresponding to red is reflected off the dichroic mirror 41r and deflected in the −X direction, and enters the projection system 51. The image light MLb having entered the light combiner 41 from the third light modulating device 33 for blue and having the third wavelength band corresponding to blue is reflected off the dichroic mirror 41b and deflected in the −X direction, and enters the projection system 51. The image light MLg having entered the light combiner 41 from the second light modulating device 32 for green and having the second wavelength band corresponding to green is not reflected off the dichroic mirror 41r or 41b but passes through the light combiner 41, and enters the projection system 51. As a result, the light combiner 41 performs image combination in which the image light MLr, the image light MLg, and the image light MLb are superimposed on one another, and outputs image light ML, which can enter the projection system 51.

The projection system 51 enlarges color images formed by the light modulating devices 31, 32, and 33 and projects the enlarged images onto a screen (not shown) to form a color image on the screen.

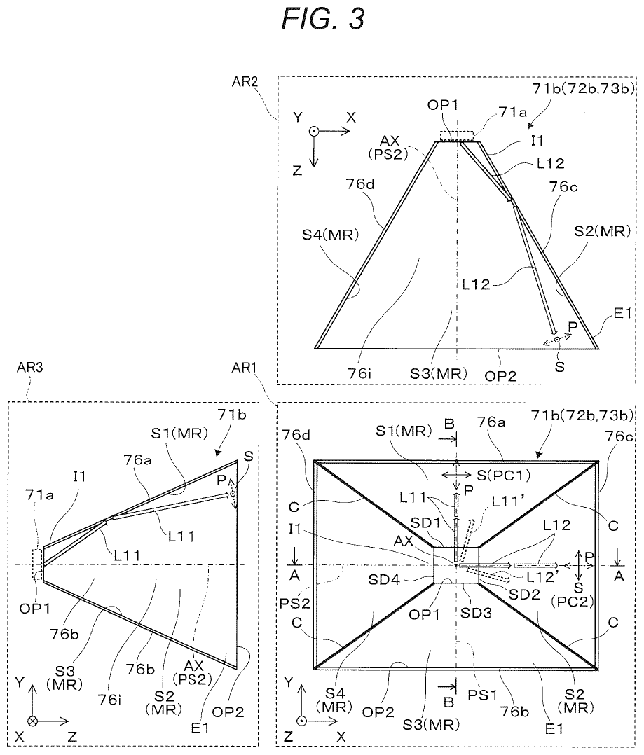

The first light guide 71b will be described with reference to FIGS. 2 and 3. FIG. 2 is a perspective view showing the interior of the first light guide 71b. In FIG. 3, a region AR1 is a front view of the first light guide 71b, a region AR2 is a cross-sectional view of the first light guide 71b shown in the region AR1 and taken along the arrow AA, and a region AR3 is a cross-sectional view of the first light guide 71b shown in the region AR1 and taken along the arrow BB.

The first light guide 71b is a tubular frame corresponding to the four side surfaces of the truncated pyramidal shape, and has the first light incident end I1, on which the first light L1 output from the first light source 71a is incident, and the first light exiting end E1, via which the first light L1 exits. An opening OP1 is formed at the first light incident end I1, and an opening OP2 is formed at the first light exiting end E1.

The first light guide 71b includes lateral plate members 76a and 76b disposed above and below, and longitudinal plate members 76c and 76d disposed left and right. The four plate members 76a, 76b, 76c, and 76d are coupled and fixed to each other via an adhesive C at the side or end portions thereof. A reflection film MR configured, for example, with a dielectric multilayer film is formed at inner surfaces 76i of the lateral plate members 76a and 76b and the longitudinal plate members 76c and 76d. That is, the first light guide 71b is a mirror having the inner surfaces 76i, which reflect the first light L1. In the present specification, the inner surface 76i of the lateral plate member 76a at the +Y side or the upper side is called a first surface S1, the inner surface 76i of the longitudinal plate member 76c at the +X side or the right side is called a second surface S2, the inner surface 76i of the lateral plate member 76b at the −Y side or the lower side is called a third surface S3, and the inner surface 76i of the longitudinal plate member 76d at the −X side or the left side is called a fourth surface S4.

The opening OP1 provided at the first light incident end I1 has a shape corresponding to the contour of the light emitting region of the first light source 71a, and the opening OP2 provided at the first light exiting end E1 has a shape corresponding to the contour of the display region of the first light modulating device 31. The opening OP1 has a rectangular shape, and has a first side SD1 contained in the first surface S1, a second side SD2 directly and indirectly coupled to the first side SD1, a third side SD3 parallel to the first side SD1 and directly or indirectly coupled to the second side SD2, and a fourth side SD4 parallel to the second side SD2 and directly or indirectly coupled to the first side SD1 and the third side SD3. The opening OP2 also has a rectangular shape, and has a first side SD1 and a third side SD3 parallel to the first side SD1 and other sides of the opening OP1, and a second side SD2 and a fourth side SD4 parallel to the second side SD2 and other sides of the opening OP1. The first side SD1 is contained in the first surface S1, the second side SD2 is contained in the second surface S2, the third side SD3 is contained in the third surface S3, and the fourth side SD4 is contained in the fourth surface S4. The optical axis AX passes through the center of the opening OP1 and the center of the opening OP2. In this case, the display region of the first light modulating device 31 has a horizontally elongated rectangular shape, and the sides of the display region in the X direction are longer than the sides of the display region in the Y direction. Therefore, the opening OP2 has a rectangular shape elongated in the X direction, and the opening OP1 has a substantially square shape, so that the area of the first surface S1, which is the inner surface 76i of the lateral plate member 76a, is equal to the area of the third surface S3, which is the inner surface 76i of the lateral plate member 76b, is greater than the area of the second surface S2, which is the inner surface 76i of the longitudinal plate member 76c, and is greater than the area of the fourth surface S4, which is the inner surface 76i of the longitudinal plate member 76d. That is, the area of the first surface S1 and the area of the third surface S3 are equal to each other, are greater than the areas of the second surface S2 and the fourth surface S4, and the first surface S1 and the third surface S3 are the largest of the surfaces S1, S2, S3, and S4, which constitute the inner surfaces 76i.

In the first light guide 71b, the reflectance of the first surface S1 of the lateral plate member 76a for the first polarized component PC1 is higher than the reflectance of the first surface S1 for the second polarized component PC2 due to the characteristics of the reflection film MR, which will be described later. Consider the first light L1 incident on the first surface S1, and the reflectance for the first polarized component PC1 corresponds to the reflectance for the S-polarized component, and the reflectance for the second polarized component PC2 corresponds to the reflectance for the P-polarized component. Similarly, the reflectance of the third surface S3 of the lateral plate member 76b for the first polarized component PC1, that is, the reflectance of the third surface S3 for the S-polarized component is higher than the reflectance of the third surface S3 for the second polarized component PC2, that is, the reflectance of the third surface S3 for the P-polarized component.

Meanwhile, the reflectance of the second surface S2 of the longitudinal plate member 76c for the first polarized component PC1 is lower than the reflectance of the second surface S2 for the second polarized component PC2 due to the characteristics of the reflection film MR, which will be described later. Consider the first light L1 incident on the second surface S2, and the reflectance for the first polarized component PC1 corresponds to the reflectance for the P-polarized component, and the reflectance for the second polarized component PC2 corresponds to the reflectance for the S-polarized component. Similarly, the reflectance of the fourth surface S4 of the longitudinal plate member 76d for the first polarized component PC1, that is, the reflectance of the fourth surface S4 for the P-polarized component is lower than the reflectance of the fourth surface S4 for the second polarized component PC2, that is, the reflectance of the fourth surface S4 for the S-polarized component.

Now, consider a reference plane PS1, which is a plane perpendicular to the first surface S1 of the upper lateral plate member 76a and passing through the optical axis AX. The reference plane PS1 extends in parallel to the YZ plane. Consider light L11 propagating along the reference plane PS1 out of the first light L1 incident on the first plane S1, and the polarization direction of the S-polarized component, which is the primary component after reflected, is perpendicular to the reference plane PS1, which is the light incident surface, but as for light L11′ propagating obliquely with respect to the reference plane PS1 out of the first light L1, the polarization direction of the S-polarized component after reflected is not exactly perpendicular to the reference plane PS1. However, the characteristics of the reflection film MR makes the first polarized component PC1, which has a polarization direction that coincides with the X direction perpendicular to the reference surface PS1, dominant in the first light L1 reflected at each point on the first surface S1, so that the first polarized component PC1 is reflected more efficiently than the second polarized component PC2.

Consider light L12 propagating along a reference plane PS2 out of the first light L1 incident on the second plane S2 of the right longitudinal plate member 76c, and the polarization direction of the S-polarized component after reflected is perpendicular to the reference plane PS2, which is the light incident surface, but as for light L12′ propagating obliquely with respect to the reference plane PS2 out of the first light L1, which is the primary component, the polarization direction of the S-polarized component after reflected is not exactly perpendicular to the reference plane PS2. However, the characteristics of the reflection film MR makes the second polarized component PC2, which has a polarization direction that coincides with the Y direction perpendicular to the reference surface PS2, dominant in the first light L1 reflected at each point on the second surface S2, so that the second polarized component PC2 is reflected more efficiently than the first polarized component PC1.

As described above, at the first surface S1 and the third surface S3, which have the largest area, of the first light guide 71b, the reflectance for the first polarized component PC1 is higher than the reflectance for the second polarized component PC2, and at the second surface S2 and the fourth surface S4, which have a smaller area, of the first light guide 71b, the reflectance for the second polarized component PC2 is higher than the reflectance for the first polarized component PC1. As a result, in the first light guide 71b, the first polarized component PC1 of the first light L1 is reflected more efficiently than the second polarized component PC2 and enters the first polarizer 81a of the first light modulating device 31, and the first polarized component PC1 is efficiently extracted by the first polarizer 81a. Note that since the second polarized component PC2 reflected off the first polarizer 81a returns to the first light guide 71b, at least part of the second polarized component PC2 is recycled, so that the efficiency at which the first light L1 is used can be increased.

The first light guide 71b has been described above, and the second light guide 72b and the third light guide 73b have the same structure as the first light guide 71b and therefore have the same reflection characteristics as the first light guide 71b.

That is, at the first surface S1 and the third surface S3, which have the largest area, of the second light guide 72b, the reflectance for the first polarized component PC1 is higher than the reflectance for the second polarized component PC2, and at the second surface S2 and the fourth surface S4, which have a smaller area, of the second light guide 72b, the reflectance for the second polarized component PC2 is higher than the reflectance for the first polarized component PC1. As a result, in the second light guide 72b, the first polarized component PC1 of the second light L2 is reflected more efficiently than the second polarized component PC2 and enters the first polarizer 82a of the second light modulating device 32, and the first polarized component PC1 is efficiently extracted by the first polarizer 82a.

Furthermore, at the first surface S1 and the third surface S3, which have the largest area, of the third light guide 73b, the reflectance for the first polarized component PC1 is higher than the reflectance for the second polarized component PC2, and at the second surface S2 and the fourth surface S4, which have a smaller area, of the third light guide 73b, the reflectance for the second polarized component PC2 is higher than the reflectance for the first polarized component PC1. As a result, in the third light guide 73b, the first polarized component PC1 of the third light L3 is reflected more efficiently than the second polarized component PC2 and enters the first polarizer 83a of the third light modulating device 33, and the first polarized component PC1 is efficiently extracted by the first polarizer 83a.

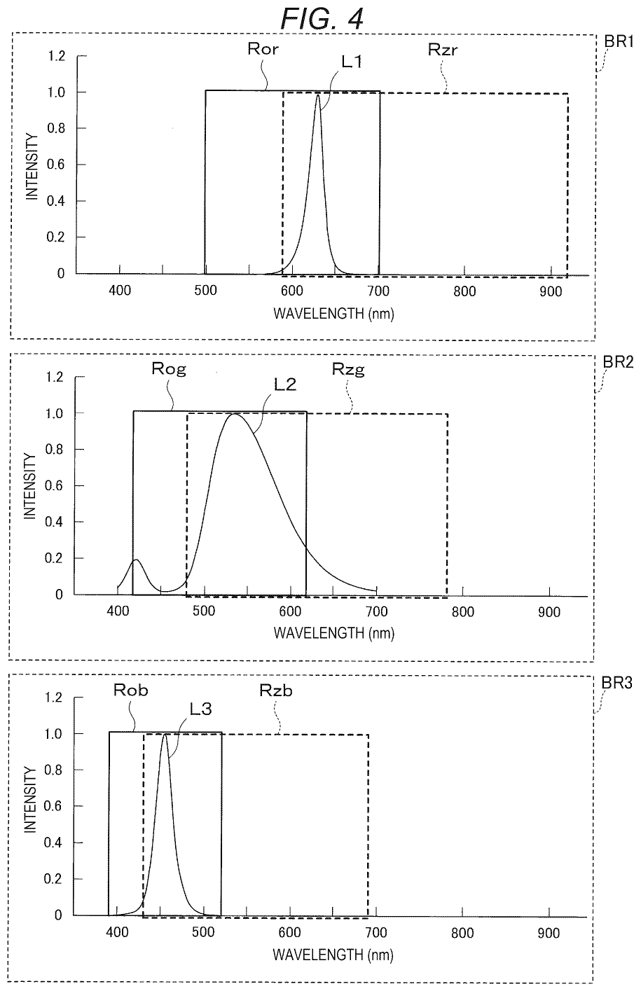

The characteristics of the light source apparatuses 21, 22, and 23 and specific reflection characteristics of the reflection films MR provided at the light guides 71b, 72b, and 73b will be described with reference to FIG. 4. In FIG. 4, a region BR1 shows the emission spectrum of the first light L1 output from the first light source apparatus 21 and the reflection characteristics of the reflection film MR provided at the inner surface 76i of the first light guide 71b. A region BR2 shows the emission spectrum of the second light L2 output from the second light source apparatus 22 and the reflection characteristics of the reflection film MR provided at the inner surface 76i of the second light guide 72b. A region BR3 shows the emission spectrum of the third light L3 output from the third light source apparatus 23 and the reflection characteristics of the reflection film MR provided at the inner surface 76i of the third light guide 73b.

The reflection films MR according to an example designed for red light, green light, and blue light are each a dielectric multilayer film or a metal film. When the reflection films MR are each a dielectric multilayer film, the reflection film MR is formed by alternately layering a layer made of a high refractive material having a relatively high refractive index and a layer made of a low refractive material having a relatively low refractive index with the outermost layer made of the low refractive material. The high refractive material can be TiO₂, Al₂O₃, or the like, and the low refractive material can be SiO₂, MgF₂, or the like. The reflection film MR according to the example designed for red light includes 20 or more film constituting layers. Similarly, the reflection film MR according to the example designed for green light includes 20 or more film constituting layers, and the reflection film MR according to the example designed for blue light includes 20 or more film constituting layers.

Table 1 below summarizes the characteristics of the dielectric multilayer films according to the example.

TABLE 1

| | Number of film | | Reflectance |
|---|---|---|---|
| | constituting | Total film | (average over |
| | layers | thickness | angles) |
| Dielectric multilayer | 20 layers or | 2000 nm or more | 90% or more |
| film for R | more | | |
| Dielectric multilayer | 20 layers or | 2000 nm or more | 90% or more |
| film for G | more | | |
| Dielectric multilayer | 20 layers or | 2000 nm or more | 90% or more |
| film for B | more | | |
| Dielectric multilayer | 30 layers or | 3000 nm or more | 90% or more |
| film for W | more | | |

In Table 1, “Reflectance” indicates the average reflectance at angles of incidence ranging from 0° to 85°. For reference, the dielectric multilayer film for W shows the characteristic of the reflection film designed for white light.

The specific number of layers of the dielectric multilayer film for R designed for red light is 62% of the number of layers of the dielectric multilayer film for W, the specific number of layers of the dielectric multilayer film for G designed for green light is 62% of the number of layers of the dielectric multilayer film for W, and the specific number of layers of the dielectric multilayer film for B designed for blue light is 58% of the number of layers of the dielectric multilayer film for W. The total film thickness of the dielectric multilayer film for R is 73% of the total film thickness of the dielectric multilayer film for W, the total film thickness of the dielectric multilayer film for G is 63% of the total film thickness of the dielectric multilayer film for W, and the total film thickness of the dielectric multilayer film for B is 48% of the total film thickness of the dielectric multilayer film for W. In the example described above, limiting the wavelength band to be used allows reduction in the number of layers of each of the reflection films MR, which are each a mirror film, by about 40%, and further allows reduction in the total number of films of the reflection film MR by about 30%.

Referring to the region BR1 in FIG. 4, the wavelength segment over which the first light L1, which is red light, is emitted extends from a wavelength of 600 nm to 650 nm. For the reflection films MR provided at the inner surfaces 76i of the first light guide 71b, a wavelength range Rzr indicated by the dotted line shows a wavelength segment over which the half-maximum reflectance, that is, 50% reflectance is ensured when the angle of incidence is 0 degrees, and a wavelength range Ror indicated by the solid line shows a wavelength segment over which the half-maximum reflectance, that is, 50% reflectance is ensured when the angle of incidence is 85 degrees. Specifically, the half-maximum wavelength range Rzr corresponding to the vertical incidence ranges from about 590 nm to 920 nm, and the half-maximum wavelength range Ror corresponding to the incidence at the greater angle of incidence ranges from about 500 nm to 700 nm. That is, the reflection films MR of the first light guide 71b are designed specifically to red light, and has satisfactory reflection characteristics for the first light L1 incident at the angles ranging from 0 degrees to 85 degrees.

Referring to the region BR2 in FIG. 4, the wavelength segment over which the second light L2, which is green light, is emitted extends from a wavelength of 480 nm to 650 nm. For the reflection films MR provided at the inner surfaces 76i of the second light guide 72b, a wavelength range Rzg indicated by the dotted line shows a wavelength segment over which the half-maximum reflectance, that is, 50% reflectance is ensured when the angle of incidence is 0 degrees, and a wavelength range Rog indicated by the solid line shows a wavelength segment over which the half-maximum reflectance, that is, 50% reflectance is ensured when the angle of incidence is 85 degrees. Specifically, the half-maximum wavelength range Rzg corresponding to the vertical incidence ranges from about 470 nm to 780 nm, and the half-maximum wavelength range Rog corresponding to the incidence at the greater angle of incidence ranges from about 420 nm to 620 nm. That is, the reflection films MR of the second light guide 72b are designed specifically to green light, and has satisfactory reflection characteristics for the second light L2 incident at the angles ranging from 0 degrees to 85 degrees.

Referring to the region BR3 in FIG. 4, the wavelength segment over which the third light L3, which is blue light, is emitted extends from a wavelength of 430 nm to 480 nm. For the reflection films MR provided at the inner surfaces 76i of the third light guide 73b, a wavelength range Rzb indicated by the dotted line shows a wavelength segment over which the half-maximum reflectance, that is, 50% reflectance is ensured when the angle of incidence is 0 degrees, and a wavelength range Rob indicated by the solid line shows a wavelength segment over which the half-maximum reflectance, that is, 50% reflectance is ensured when the angle of incidence is 85 degrees. Specifically, the half-maximum wavelength range Rzb corresponding to the vertical incidence ranges from about 430 nm to 690 nm, and the half-maximum wavelength range Rob corresponding to the incidence at the greater angle of incidence ranges from about 390 nm to 520 nm. That is, the reflection films MR of the third light guide 73b are designed specifically to blue light, and has satisfactory reflection characteristics for the third light L3 incident at the angles ranging from 0 degrees to 85 degrees.

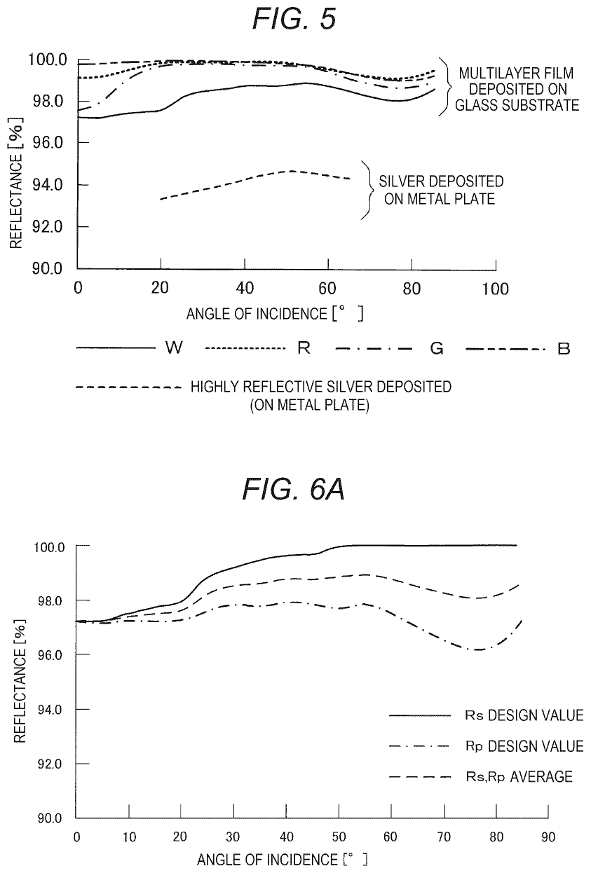

FIG. 5 is a chart for illustrating the dependence of the reflectance of the reflection films MR formed at the light guides 71b, 72b, and 73b on the angle of incidence. The solid line, the dotted line, the single-dot chain line, and the two-dot chain line indicate the reflectance of the reflection films MR produced by forming dielectric multilayer films on glass substrates through vapor deposition, and the broken line indicates the reflectance of the reflection film MR produced by forming a silver layer on a metal plate through vapor deposition. Out of the characteristics of the reflection films MR configured with the dielectric multilayer films, the dotted line indicates the dependence of the reflectance at the peak wavelength of the red light or the first light L1 on the angle of incidence, the single-dot chain line indicates the dependence of the reflectance at the peak wavelength of the green light or the second light L2 on the angle of incidence, and the two-dot chain line indicates the dependence of the reflectance at the peak wavelength of the blue light or the third light L3 on the angle of incidence. Note that the solid line is drawn for reference, and shows the dependence of the reflectance of a reflection film designed for white light on the angle of incidence. The characteristics of the reflection film MR configured with a metal film that is a silver layer hardly have wavelength dependence. The silver layer can be replaced with an aluminum layer. The silver layer or the aluminum layer can each be an enhanced reflection film, in which case, a multilayer film is formed at the silver layer or the aluminum layer.

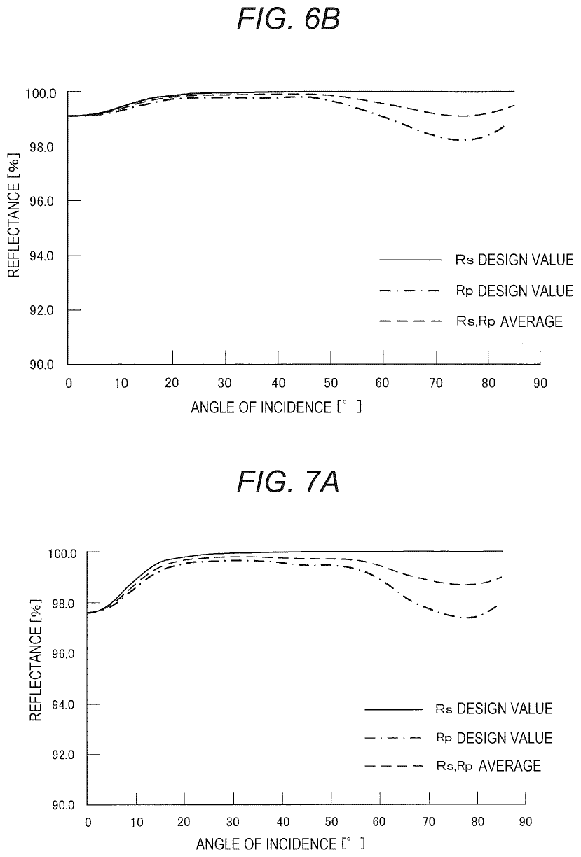

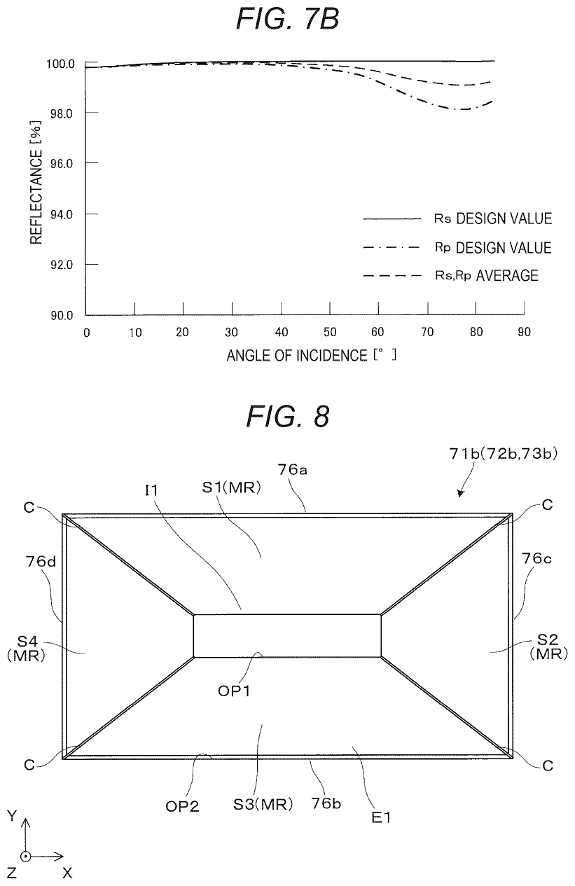

FIG. 6A shows the dependence of the reflectance of the reflection film MR designed for white light on the angle of incidence, and FIG. 6B shows the dependence of the reflectance of the reflection film MR designed for red light, that is, the first light L1 on the angle of incidence. FIG. 7A shows the dependence of the reflectance of the reflection film MR designed for green light, that is, the second light L2 on the angle of incidence, and FIG. 7B shows the dependence of the reflectance of the reflection film MR designed for blue light, that is, the third light L3 on the angle of incidence. As is clear from the chart shown above, the characteristics of the reflection film MR for the multiple colors each show high reflectance for the S-polarized light. It is therefore understood that the efficiencies at which the light L1, the light L2, and the light L3 output from the light source apparatuses 21, 22, and 23 are used are increased by directly using the S-polarized light reflected off the surfaces having a large reflection area in the light guides 71b, 72b, and 73b, that is, the reflection films MR provided at the lateral plate members 76a and 76b. The S-polarized light reflected off the reflection films MR provided at the lateral plate members 76a and 76b corresponds to the first polarized component PC1, specifically, the light having a polarization direction or an electric field oscillation direction parallel to the X-axis in FIG. 2.

In the case of the dielectric multilayer film for R designed for red light, it has been ascertained that the reflectance for the red light can be improved as shown in FIG. 6B by employing a configuration in which the dielectric multilayer film for R includes 20 to 60 layers. In the case of the dielectric multilayer film for G designed for green light, it has also been ascertained that the reflectance for the green light can be improved as shown in FIG. 7A by employing a configuration in which the dielectric multilayer film for G includes 20 to 60 layers. In the case of the dielectric multilayer film for B designed for blue light, it has also been ascertained that the reflectance for the blue light can be improved as shown in FIG. 7B by employing a configuration in which the dielectric multilayer film for B includes 20 to 60 layers.

FIG. 8 is a front view for illustrating a variation of the first light guide 71b shown in FIG. 2 and the like. In this case, the opening OP1 provided at the first light incident end I1 and the opening OP2 provided at the first light exiting end E1 each have a laterally elongated rectangular contour. That is, in the first light guide 71b in the variation shown in FIG. 8, the aspect ratio and size of each of the openings OP1 and OP2 greatly differ from those of the first light guide 71b shown, for example, in FIG. 2. Even when the aspect ratio and size of each of the openings OP1 and OP2 vary as described above, the area of each of the lateral plate members 76a and 76b is greater than the area of each of the longitudinal plate members 76c and 76d, and the efficiency at which the light L1, the light L2, and the light L3 output from the light source apparatuses 21, 22, and 23 are used is increased by using the S-polarized light reflected off the lateral plate members 76a and 76b. When the area of the opening OP1 is sufficiently smaller than that of the opening OP2, the area of each of the plate members extending in the lengthwise direction of the opening OP2 is usually larger than the area of each of the plate members extending in the widthwise direction of the opening OP2. In this case, it is desirable to use the light polarized in parallel to the lengthwise direction of the opening OP2 as the first polarized component to illuminate the light modulating devices 31, 32, and 33.

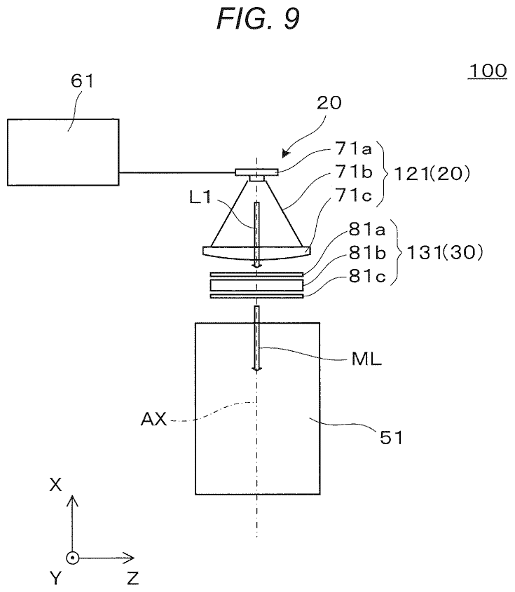

FIG. 9 is a plan view for illustrating a variation of the projector 100 shown in FIG. 1. The projector 100 includes only a first light source apparatus 121 as the illuminator 20, and includes only a first light modulating device 131 as the light modulating apparatus 30. The first light source apparatus 121 outputs red light, green light, and blue light, or white light as the first light L1. The projection system 51 enlarges a monochromatic or color image formed by the first light modulating device 131 and projects the enlarged image onto a screen (not shown).

The projector 100 according to the embodiment described above includes the first light source 71a, which outputs the first light L1 having the first wavelength band, the first light guide 71b, which has the first light incident end I1, on which the first light L1 output from the first light source 71a is incident, and the first light exiting end E1, via which the first light L1 exits, the first light modulator 81b, which modulates the first light L1 output from the first light guide 71b based on image information to generate the image light MLr having the first wavelength band, and the projection system 51, which projects the light modulated by the first light modulator 81b, the first light L1 output from the first light source 71a containing the first polarized component PC1 and the second polarized component PC2, the first light guide 71b having the inner surfaces 76i, which reflect the first light L1, the inner surfaces 76i including the first surface S1, which is the largest of the surfaces S1, S2, S3, and S4, which constitute the inner surfaces 76i, the reflectance of the first surface S1 for the first polarized component PC1 being higher than the reflectance of the first surface S1 for the second polarized component PC2, the first light modulator 81b modulating the first polarized component PC1 to generate the image light MLr.

In the projector 100 described above, since the reflectance of the first surface S1 having the largest area for the first polarized component PC1 is higher than the reflectance of the first surface S1 for the second polarized component PC2, and an image is formed by using the first polarized component PC1 efficiently reflected off the largest first surface S1, so that the light use efficiency is improved. In this process, since polarization conversion or the like is not performed on the light source light by using other parts, an increase in the size of the Illuminator can be suppressed.

The projector 100 according to the embodiment described above further includes the second light source 72a, which outputs the second light L2 having the second wavelength band, the third light source 73a, which outputs the third light L3 having the third wavelength band, the second light guide 72b, which has the second light incident end 12, on which the second light L2 output from the second light source 72a is incident, and the second light exiting end E2, via which the second light L2 exits, the third light guide 73b, which has the third light incident end 13, on which the third light L3 output from the third light source 73a is incident, and the third light exiting end E3, via which the third light L3 exits, the second light modulator 82b, which modulates the second light output from the second light guide 72b based on image information to generate the image light MLg having the second wavelength band, the third light modulator 83b, which modulates the third light L3 output from the third light guide 73b based on image information to generate the image light MLb having the third wavelength band, and the light combiner 41, which combines the light output from the first light modulator 81b, the light output from the second light modulator 82b, and the light output from the third light modulator 83b with one another and outputs the combined light to the projection system 51.

The projector 100 described above is a projector that directly radiates the three light modulators 81b, 82b, and 83b by using the three light sources 71a, 72a, and 73a, which output three kinds of color light, and has separate optical paths on a color light basis, so that one optical path does not need to be divided into multiple optical paths. Therefore, the optical system can be simplified, and the number of colors to be displayed can be increased. Furthermore, in the projector 100 described above, which forms an image by using the first polarized component PC1 efficiently reflected off the largest first surface S1 in each of the light guides 71b, 72b, and 73b, so that the light use efficiency is improved.

### Other Variations

The present disclosure has been described above with reference to the embodiment, but is not limited to the embodiment described above, and can be implemented in various forms without departing from the gist of the present disclosure. For example, variations below are conceivable.

The lateral plate members 76a and 76b and the longitudinal plate members 76c and 76d are each not limited to a planar surface, and may be any of various curved surfaces which are, for example, a concave or convex curved spherical surface, or a concave or convex cylindrical surface.

The reflection films MR in the light guides 71b, 72b, and 73b are assumed to receive the light L1, the light L2, and the light L3 incident at the angles of incident ranging from 0 degrees to 85 degrees, but not necessarily, and the films may be designed on the assumption that the light L1, the light L2, and the light L3 are incident at angles ranging, for example, from 20 degrees to 70 degrees.

The reflection films MR of the lateral plate members 76a and 76b are the same as those of the longitudinal plate members 76c and 76d in the above description. Instead, the reflectance of the reflection films MR of the lateral plate members 76a and 76b for the S-polarized component may be increased, while the reflectance of the reflection films MR of the longitudinal plate members 76c and 76d for the P-polarized component may be made higher than the reflectance of the reflection films MR of the lateral plate members 76a and 76b for the P-polarized component. In this case, the first polarized component PC1 can be efficiently extracted from the light reflected off the longitudinal plate members 76c and 76d.

The first light guide 71b, the second light guide 72b, and the third light guide 73b are each not limited to a light guide having a quadrangular tubular shape, and may instead be configured with a plastic or glass solid block. In this case, forming a multilayer film or a monolayer mirror film at the side surface of the solid block allows an increase in the reflectance for the S-polarized light, and efficient extraction of the first polarized component PC1.

The light modulating devices 31, 32, and 33 need not be transmissive light modulating devices and may be reflective light modulating devices.

The light sources 71a, 72a, and 73a are not limited to LEDs and may instead be laser diodes (LDs).

### Summary of Present Disclosure

The present disclosure will be summarized below in the form of additional remarks.

### Additional Remark 1

A projector including:
a first light source configured to output first light having a first wavelength band;
a first light guide having a first light incident end on which the first light output from the first light source is incident, and a first light exiting end via which the first light exits;
a first light modulator configured to modulate the first light output from the first light guide based on image information to generate first image light having the first wavelength band; and
a projection system configured to project the light modulated by the first light modulator,
wherein the first light output from the first light source contains a first polarized component and a second polarized component,
the first light guide has an inner surface configured to reflect the first light,
the inner surface includes a first surface having a largest area out of surfaces that constitute the inner surface,
reflectance of the first surface for the first polarized component is higher than reflectance of the first surface for the second polarized component, and
the first light modulator is configured to modulate the first polarized component to generate the first image light.

In the projector described above, the reflectance of the first surface having the largest area for the first polarized component is higher than the reflectance of the first surface for the second polarized component, and an image is formed by using the first polarized component efficiently reflected off the largest first surface, so that the light use efficiency is improved. In this process, since polarization conversion or the like is not performed on the light source light by using other parts, an increase in the size of the illuminator can be suppressed.

### Additional Remark 2

The projector according to the additional remark 1, further including
a first polarizer disposed between the first light guide and the first light modulator, and configured to transmit light having the first polarized component and attenuate light having the second polarized component. The first polarizer attenuates the light having the second polarized component through reflection and absorption.

In the projector described above, particularly when the first polarizer attenuates the light having the second polarized component through reflection, the light use efficiency can be improved by causing the light reflected off the first polarizer to enter the light guide again.

### Additional Remark 3

The projector according to the additional remark 1, wherein
the first light guide has a rectangular cross-sectional shape perpendicular to an optical axis of the first light guide.

The projector described above, in which the first light guide has a rectangular cross-sectional shape, which is a simple shape, can generate illumination light having a uniform illuminance distribution with which a rectangular region is illuminated.

### Additional Remark 4

The projector according to any one of the additional remarks 1 to 3, wherein
a light-incident-side opening of the first light guide has a first side contained in the first surface, a second side coupled to the first side, a third side parallel to the first side and coupled to the second side, and a fourth side parallel to the second side and coupled to the first and third sides,
an area of a third surface containing the third side is equal to an area of the first surface, and
reflectance of the third surface for the first polarized component is higher than reflectance of the third surface for the second polarized component.

In the projector described above, since the area of each of the first and third surfaces is larger than an area of a second surface or the like, and the light efficiently reflected off the first and third surfaces each having a large area is used to form an image, so that the light use efficiency is improved.

### Additional Remark 5

The projector according to any one of the additional remarks 1 to 4, wherein
the first polarized component is an S-polarized component with respect to the first surface.

In the projector described above, the first polarized component is the S-polarized component with respect to the first surface, so that the reflection efficiency at the first surface is likely to be improved.

### Additional Remark 6

The projector according to any one of the additional remarks 1 to 5, wherein
the inner surface of the first light guide includes a reflection film configured to reflect the first light, and
the reflection film is a dielectric multilayer film.

In the projector described above, since the reflection film provided at the inner surface of the first light guide is a dielectric multilayer film, desired reflection film characteristics can be realized by properly designing the dielectric multilayer film.

### Additional Remark 7

The projector according to the additional remark 6, wherein
the first light is red light, and
wavelengths at which the dielectric multilayer film has half-maximum reflectance for the first light incident at 0 degrees range from 590 to 920 nm.

### Additional Remark 8

The projector according to the additional remark 6, wherein
the first light is green light, and
wavelengths at which the dielectric multilayer film has half-maximum reflectance for the first light incident at 0 degrees range from 470 to 780 nm.

### Additional Remark 9

The projector according to the additional remark 6, wherein
the first light is blue light, and
wavelengths at which the dielectric multilayer film has half-maximum reflectance for the first light incident at 0 degrees range from 430 to 690 nm.

### Additional Remark 10

The projector according to any one of the additional remarks 6 to 9, wherein
the dielectric multilayer film is formed by alternately layering a layer made of a high refractive material and a layer made of a low refractive material on each other with an outermost layer made of the low refractive material, and
the number of layers of the dielectric multilayer film is greater than or equal to 20 but smaller than or equal to 60.

### Additional Remark 11

The projector according to the additional remark 1, further including:
a second light source configured to output second light having a second wavelength band;
a third light source configured to output third light having a third wavelength band;
a second light guide having a second light incident end on which the second light output from the second light source is incident, and a second light exiting end via which the second light exits;
a third light guide having a third light incident end on which the third light output from the third light source is incident, and a third light exiting end via which the third light exits;
a second light modulator configured to modulate the second light output from the second light guide based on image information to generate second image light having the second wavelength band;
a third light modulator configured to modulate the third light output from the third light guide based on image information to generate third image light having the third wavelength band; and
a light combiner configured to combine the light output from the first light modulator, the light output from the second light modulator, and the light output from the third light modulator with one another and output the combined light to the projection system.

The projector described above is a projector that directly radiates the three light modulators by using the three light sources, which output three kinds of color light, and therefore has separate optical paths on a color light basis, so that one optical path does not need to be divided into multiple optical paths. Therefore, the optical system can be simplified, and the number of colors to be displayed can be increased. Furthermore, in the projector described above, which forms an image by using the first polarized component efficiently reflected off the largest first surface of at least the first light guide, so that the light use efficiency is improved. Note that in addition to the first light guide, it is desirable in the second and third light guides that the reflectance of the largest first surface for the first polarized component be higher than the reflectance of the first surface for the second polarized component.

What is claimed is:

1. A projector comprising:
a first light source configured to output first light having a first wavelength band;
a first light guide having a first light incident end on which the first light output from the first light source is incident, and a first light exiting end via which the first light exits;
a first light modulator configured to modulate the first light output from the first light guide based on image information to generate first image light having the first wavelength band; and
a projection system configured to project the light modulated by the first light modulator,
wherein the first light output from the first light source contains a first polarized component and a second polarized component,
the first light guide has an inner surface configured to reflect the first light,
the inner surface includes a first surface having a largest area out of surfaces that constitute the inner surface,
reflectance of the first surface for the first polarized component is higher than reflectance of the first surface for the second polarized component, and
the first light modulator is configured to modulate the first polarized component to generate the first image light.

2. The projector according to claim 1, further comprising
a first polarizer disposed between the first light guide and the first light modulator, and configured to transmit light having the first polarized component and attenuate light having the second polarized component.

3. The projector according to claim 1, wherein
the first light guide has a rectangular cross-sectional shape perpendicular to an optical axis of the first light guide.

4. The projector according to claim 1, wherein
a light-incident-side opening of the first light guide has a first side contained in the first surface, a second side coupled to the first side, a third side parallel to the first side and coupled to the second side, and a fourth side parallel to the second side and coupled to the first and third sides,
an area of a third surface containing the third side is equal to an area of the first surface, and
reflectance of the third surface for the first polarized component is higher than reflectance of the third surface for the second polarized component.

5. The projector according to claim 1, wherein
the first polarized component is an S-polarized component with respect to the first surface.

6. The projector according to claim 1, wherein
the inner surface of the first light guide includes a reflection film configured to reflect the first light, and
the reflection film is a dielectric multilayer film.

7. The projector according to claim 6, wherein
the first light is red light, and
wavelengths at which the dielectric multilayer film has half-maximum reflectance for the first light incident at 0 degrees range from 590 to 920 nm.

8. The projector according to claim 6, wherein
the first light is green light, and
wavelengths at which the dielectric multilayer film has half-maximum reflectance for the first light incident at 0 degrees range from 470 to 780 nm.

9. The projector according to claim 6, wherein
the first light is blue light, and
wavelengths at which the dielectric multilayer film has half-maximum reflectance for the first light incident at 0 degrees range from 430 to 690 nm.

10. The projector according to claim 6, wherein
the dielectric multilayer film is formed by alternately layering a layer made of a high refractive material and a layer made of a low refractive material on each other with an outermost layer made of the low refractive material, and
the number of layers of the dielectric multilayer film is greater than or equal to 20 but smaller than or equal to 60.

11. The projector according to claim 1, further comprising:
a second light source configured to output second light having a second wavelength band;
a third light source configured to output third light having a third wavelength band;
a second light guide having a second light incident end on which the second light output from the second light source is incident, and a second light exiting end via which the second light exits;
a third light guide having a third light incident end on which the third light output from the third light source is incident, and a third light exiting end via which the third light exits;
a second light modulator configured to modulate the second light output from the second light guide based on image information to generate second image light having the second wavelength band;
a third light modulator configured to modulate the third light output from the third light guide based on image information to generate third image light having the third wavelength band; and
a light combiner configured to combine the light output from the first light modulator, the light output from the second light modulator, and the light output from the third light modulator with one another and output the combined light to the projection system.
